(19) United States
(12) Patent Application Publication
(10) Pub. No.: US 2010/0203842 A1
(43) Pub. Date: Aug. 12, 2010

(54) Wireless communication terminal apparatus, wireless communication system and wireless communication method

(75) Inventors: Koichi Tachikawa, Kanagawa (JP); Yoshio Watanabe, Kanagawa (JP)

Correspondence Address: PROCOPIO, CORY, HARGREAVES & SAVITCH LLP, 525 B STREET, SUITE 2200, SAN DIEGO, CA, 92101, US

(73) Assignee: KYOCERA CORPORATION, Kyoto (JP)

(21) Appl. No.: 12/671,302

(22) PCT Filed: Jul. 30, 2008
(86) PCT No.: PCT/JP2008/063658

§ 371 Date: Feb. 23, 2010

(30) Foreign Application Priority Data
Jul. 30, 2007 (JP) 2007-197206

(51) Int. Cl. H04B 1/38

(52) U.S. Cl. 455/73

(57) ABSTRACT

A wireless communication terminal apparatus 10 is comprised of a plurality of antennas Ant1 and Ant2, a switch circuit 11 for switching to one selected antenna among the plurality of antennas Ant1 and Ant2, for carrying out a communication, and a control unit 14 for selecting another antenna among antennas in a non-selection status in response to the status of the reception signal, in a case where a status of a reception signal of an antenna in a selection status is not in the predetermined condition, and regardless a status of the reception signal of the antennas in a non-selection status, and controlling the switch circuit for making the switching of another antenna in a non-selection status at a transmission.

### CROSS REFERENCE TO RELATED APPLICATIONS

This application is the U.S. National Stage application of PCT application PCT/JP2008/063658 filed on Jul. 30, 2008, which claims priority under 35 U.S.C. §119 to Japanese Patent Application No. 2007-197206 filed on Jul. 30, 2007, and the contents of each of these applications are incorporated herein by reference in their entirety

### FIELD OF THE INVENTION

The present invention relates to a wireless communication terminal apparatus, a wireless communication system, and a wireless communication method.

### BACKGROUND

For example, as described in a patent document 1, there is known a scheme of a wireless communication terminal apparatus for diversity system comprising two systems of antennas for improvement of a communication performance, and carrying out the communication by switching to either one antenna of which a status of a received signal is good to another status of another reception signal.

The status of the reception signal may be, for example, a value of reception level or a value of bit error rate.

A wireless communication terminal apparatus for diversity system, for example, carries out the communication with another wireless communication terminal or the like, via a communication network connected to a base station comprising an adaptive array antenna. The wireless communication terminal apparatus, for example, carries out the communication with the base station to identify a reception area or the like, in which the wireless communication terminal apparatus is positioned.

An example of a switching operation of the antenna which is carried out at the time where such wireless communication terminal apparatus for diversity system carries out the communication with the base station, will be explained.

FIG. 5 is a view explaining an example of the switching operation of the antenna which is carried out at the time where the wireless communication terminal apparatus for diversity system carries out the communication with the base station. In the explanation referring the content illustrated in FIG. 5, a signal transmitted by the wireless communication terminal apparatus or the base station is referred as Tx, a signal which is received by the apparatus or the station is referred as Rx. Also, at the time t1, it is supposed that an antenna AntA is selected.

As shown in FIG. 5, at the time t1, the wireless communication terminal apparatus transmits a signal Tx as a transmission signal Tx to the base station by means of the antenna AntA. The base station receives the signal Tx as a reception signal Rx from the antenna AntA provided on the wireless communication terminal apparatus.

At the time t2, the base station transmits the signal Tx to the antenna AntA which was used by the wireless communication terminal apparatus at the transmission. The wireless communication terminal apparatus receives that signal Tx as the reception signal Rx by means of the antenna AntA from the base station.

After that, for example, at the time t4, it is supposed that a communication quality obtained by carrying out the communication of the wireless communication terminal apparatus by the antenna AntA is lowered due to a reduction of electric intensity of radio wave.

At this time, the wireless communication terminal apparatus receives the signal Tx as the reception signal Rx by means of the antenna AntA from the base station. At this time, the wireless communication terminal apparatus compares the reception status at this time with the reception status before the time t4. As a result, it is supposed that the wireless communication terminal apparatus judges that the status of the reception signal of the antenna AntB is better than that of the antenna AntA.

At the time t5, the wireless communication terminal apparatus transmits the signal Tx to the base station by means of the antenna AntA. The base station receives that signal Tx as the reception signal Rx.

The wireless communication terminal apparatus, at the time t6 for receiving the signal Rx at a next communication, switches, as an antenna to be used, to the antenna AntB of which a reception sensitivity is good, and receives the signal Rx by the means of this antenna AntB from the base station.

Patent document 1: Japanese Unexamined (Kokai) Patent Publication No. 6-268635 (A)

### SUMMARY

A wireless communication terminal apparatus suitably selects an antenna to be used in response to a status of a reception signal at the time of receiving a signal from a base station. The base station comprising an adaptive array antenna transmits a signal by controlling a directivity of the antenna which was used by the wireless communication terminal apparatus at the time of transmitting the signal.

However, since a switching by which the wireless communication terminal apparatus performs in response to the status of the reception signal is performed at the time of receiving the signal, for example, at the time t6 shown in FIG. 5, there may be different between an antenna of an object to which the base station should transmit a signal, and another antenna by which the wireless communication terminal apparatus performs a reception. In this case, the wireless communication terminal apparatus can not accurately measure a reception level of the switched antenna when receiving the signal from the base station.

Therefore, there is desired to provide a wireless communication terminal apparatus, a wireless communication system, and a wireless communication method, carrying out a smooth communication with a base station.

A wireless communication terminal apparatus according to the present invention is comprised of: a plurality of antennas; a switch circuit for switching to one selected antenna among the plurality of antennas, for carrying out a communication; a control unit for selecting another antenna among antennas in a non-selection status in response to the status of the reception signal, in a case where a status of a reception signal of an antenna in a selection status is not in the predetermined condition, and regardless a status of the reception signal of the antennas in a non-selection status, and controlling the switch circuit for making the switching of another antenna in a non-selection status at a transmission.

Preferably, the plurality of antennas are comprised of a first antenna and a second antenna, the reception status is large or small of the reception error rate, and the control unit controls, in a case where the reception error rate is greater than or equal to the predetermined reception error rate, the switch circuit for making the switching from the selected first antenna to the second antenna in a non-selection status.

Preferably, the plurality of antennas are comprised of the first antenna and the second antenna, the reception status is high or low of the reception level, and the control unit controls, in a case where the reception level is less than or equal to the predetermined reception level, the switch circuit for making the switching from the selected first antenna to the second antenna in a non-selection status.

Preferably, a communication object is comprised of an adaptive array antenna.

A wireless communication system according to the present invention in which a wireless communication terminal apparatus and a base station for carrying out a communication with the wireless communication terminal apparatus are connected to a network, is comprised of the wireless communication terminal apparatus comprising: a plurality of antennas; a switch circuit for switching to one selected antenna among the plurality of antennas, for carrying out a communication; a control unit for selecting another antenna among antennas in a non-selection status in response to the status of the reception signal, in a case where a status of a reception signal of an antenna in a selection status is not in the predetermined condition, and regardless a status of the reception signal of the antennas in a non-selection status, and controlling the switch circuit for making the switching of another antenna in a non-selection status at a transmission.

A wireless communication method according to the present invention is comprised of: a step for switching to one selected antenna among a plurality of antennas, for carrying out a communication; a step for selecting another antenna among antennas in a non-selection status in response to the status of the reception signal, in a case where a status of a reception signal of an antenna in a selection status is not in the predetermined condition, and regardless a status of the reception signal of the antennas in a non-selection status, and controlling the switch circuit for making the switching of another antenna in a non-selection status at a transmission.

According to the present invention, it is possible to provide a wireless communication terminal apparatus, a wireless communication system, and a wireless communication method, carrying out a smooth communication with a base station.

### BRIEF DESCRIPTION OF THE DRAWINGS

FIG. 1 is a system configuration view explaining an example of a wireless communication system applied to a wireless communication terminal apparatus, as a wireless communication terminal apparatus according to the present embodiment.

FIG. 2 is a block diagram showing an example of configuration of the wireless communication terminal apparatus according to the present embodiment.

FIG. 3 is a view showing an example of a switching operation of an antenna, which is carried out at the time where the wireless communication terminal apparatus according to the present embodiment carries out the communication with the base station.

FIG. 4 is a flowchart showing an example of the operation of the communication wireless system according to the present embodiment.

FIG. 5 is a view explaining an example of a switching operation of an antenna, which is carried out at the time where a wireless communication terminal apparatus for diversity system carries out the communication with a base station.

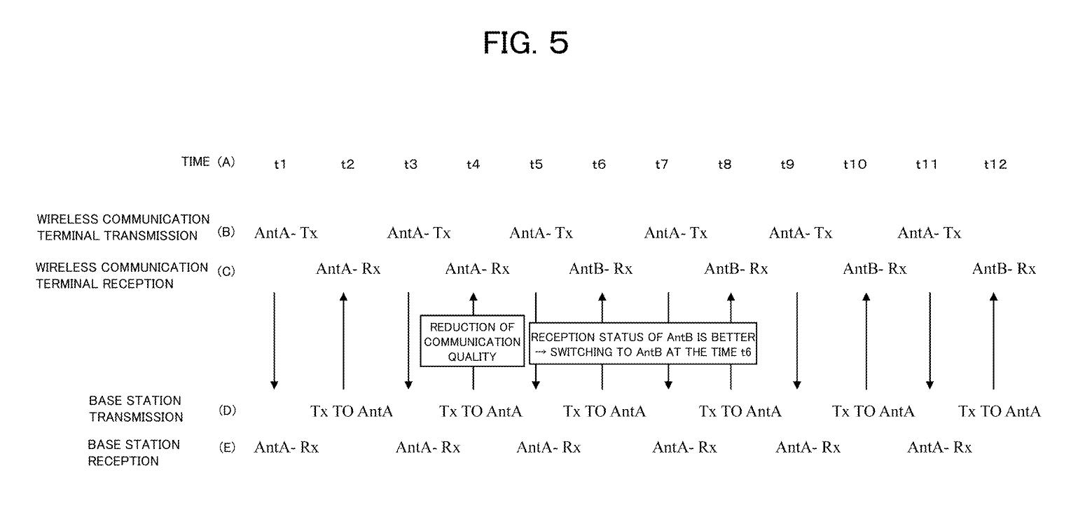

### DETAILED DESCRIPTION

Embodiments of the present invention will be explained with reference to the accompanying drawings.

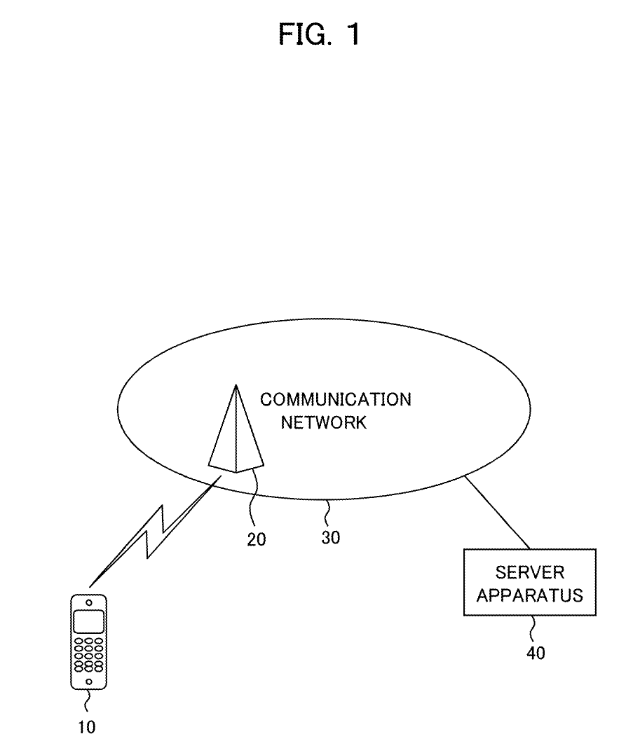

FIG. 1 is a system configuration view explaining an example of a wireless communication system in which a wireless communication terminal apparatus according to the present embodiment is applied.

As shown in FIG. 1, the wireless communication system according to the present embodiment is configured by a wireless communication terminal apparatus 10, a base station 20 as a communication object, a communication network 30, and a server apparatus 40.

The wireless communication terminal apparatus 10 is a wireless communication terminal apparatus for diversity system comprising two antennas, aparted from each other, and/or, having different forms. The wireless communication terminal apparatus 10 carries out a communication by switching to either one antenna in response to a status of a reception signal from the base station 20. The wireless communication terminal apparatus 10 performs a data communication or an audio communication on the basis of a control of the server apparatus 40 connected to the communication network 30 via the base station 20 by using radio wave.

The base station 20 has, for example, an adaptive array antenna, and carries out the communication or the like, with the wireless communication terminal apparatus to identify a reception area or the like, in which the wireless communication terminal apparatus is positioned. The base station 20 transmits a signal to one antenna used by which the communication terminal apparatus 10 transmitted the signal, by controlling a directivity of the adaptive array antenna.

The server apparatus 40 performs a transmission and reception of the data and audio or the like, via the communication network 30.

The wireless communication terminal apparatus 10 according to the present embodiment is, for example, a PHS (Personal Handy phone System) phone or a cellular phone.

The wireless communication terminal apparatus 10 according to the present embodiment will be explained.

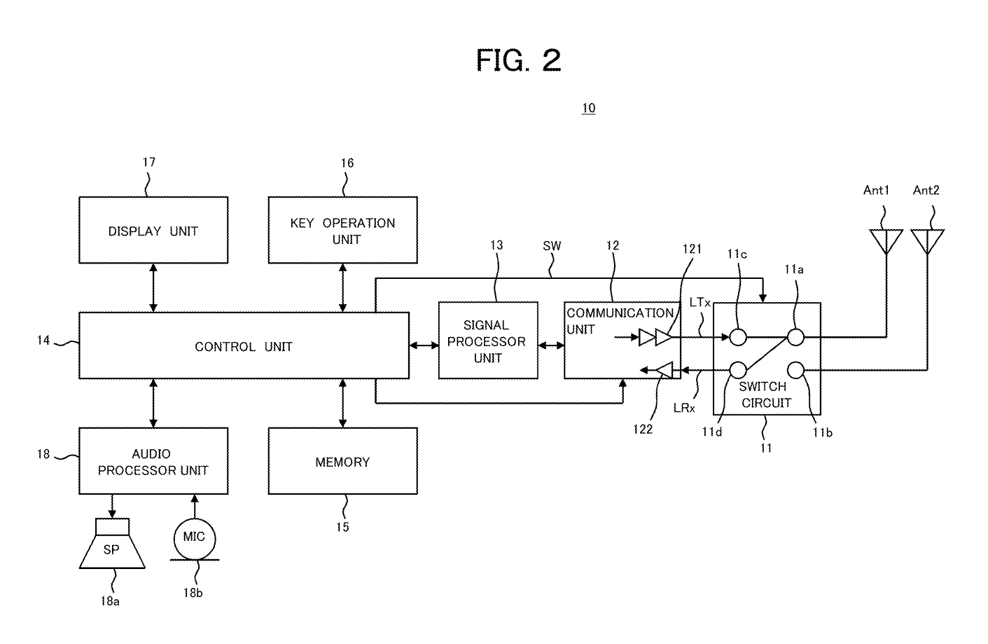

FIG. 2 is a block diagram showing an example of configuration of the wireless communication terminal apparatus according to the present embodiment.

As shown in FIG. 2, the wireless communication terminal apparatus 10 is comprised of a first antenna Ant1, a second antenna Ant2, a switch circuit 11, a communication unit 12, a signal processor unit 13, a control unit 14, a memory 15, a key operation unit 16, a display unit 17, an audio processor unit 18, a speaker 18a, and a microphone 18b.

The first antenna Ant1 and the second antenna Ant2 are, for example, arranged separately such that the both antennas are adaptive for a diversity system, and connected to the switch circuit 11. The first antenna Ant1 and the second antenna Ant2 may be different type of antennas each other. The switched antenna transmits the predetermined radio wave toward the base station 20 shown in FIG. 1, or receives the predetermined radio wave from the base station 20.

The two antennas according to the present embodiment are, for example, antennas built in the wireless communication terminal apparatus 10. Either one antenna or the both antennas may be, for example, an rod antenna(s) or the like, or other type of antenna(s).

The switch circuit 11 has terminals 11a, 11b, 11c, and 11d for switching between the antenna Ant1 and the antenna Ant2. The terminal 11a is connected to the antenna Antl. The terminal 11b is connected to the antenna Ant2. The terminal 11c is connected to the communication unit 12 by a signal line LTx. The terminal 11d is connected to the communication unit 12 by a signal line LRx.

Based on a switching signal SW outputted from the control unit 14, the terminal 11c side is switched to the terminal 11a side or the terminal 11b side. The terminal 11d side is switched to the terminal 11a side or the terminal 11b side.

In the switch circuit 11 shown in FIG. 2, the terminal 11c side and the terminal 11a side are connected. The terminal 11d side and the terminal 11a side are connected. Namely, the antenna Ant1 is selected by the switch circuit 11.

By this switching, a signal which is outputted to the signal line LTx by the communication unit 12 is propagated to the antenna Ant1. The signal which is received by the antenna Ant1 is propagated to the communication unit 12 through the signal line LRx.

The communication unit 12 is comprised of, for example, an amplifier 121, a LNA (Low Noise Amplifier) 122, a not illustrated reception circuit and a transmission circuit, and other circuit(s). The amplifier 121 is connected to the terminal 11c of the switch circuit 11 through the signal line LTx. The LNA 122 is connected to the terminal 11d of the switch circuit 11 through the signal line LRx.

The communication unit 12 outputs a signal amplified by the amplifier 121 to the selected antenna through the signal line LTx when transmitting the signal. The communication unit 12 is inputted a signal from the selected antenna through the signal line LRx when receiving the signal. The LNA 122 reduces noise of this reception signal and amplifies the same.

The transmission and reception in the communication unit 12 is controlled by the control unit 14. The reception circuit of the communication unit 12 performs a demodulation of the reception signal Rx from the base station 20 in response to a corresponding modulation system, and outputs the demodulated signal to the signal processor unit 13.

As the demodulation system according to the present embodiment, for example, BPSK (Binary Phase Shift Keying), QPSK (Quadrature Phase Shift Keying), 8PSK (Phase Shift Keying), 16QAM (Quadrature phase Amplitude Modulation) or 32QAM, may be used in response to a corresponding modulation system of the transmission signal transmitted from the base station 20.

The signal processor unit 13 has an encoder, and outputs a transmission signal such as an audio or the like, encoded by this encoder.

The control unit 14 is mainly configured by a microcomputer. The control unit 14 is connected to the switch circuit 11, the communication unit 12, the signal processor unit 13, the memory 15, the key operation unit 16, the display unit 17, and the audio processor unit 18, respectively.

The control unit 14 performs the control of the whole wireless communication terminal apparatus 10. The control unit 14 performs, for example, the control of the switch circuit 11, the control of a transmission and reception by the communication unit 12, an inputting and outputting a signal from and to the signal processor unit 13, the control of an access to the memory 15, the processing in response to an input information by the key operation unit 16, displaying various information to the display unit 17, and the control of the audio processor unit 18, or the like.

The control unit 14 monitors a status of a reception signal of the selected antenna of which the reception signal was inputted through the signal processor unit 13, at every time of receiving the reception signal, and judges that the status of the reception signal is in the predetermined condition or not.

The status of the reception signal may be, for example, large or small of a reception signal level or a reception error rate. The reception error rate means, for example, an error rate of a signal, and may be a frame error rate (FER). The higher the reception error rate may result in an introduction of a larger noise in/on an audio or a picture.

The control unit 14 selects an antenna in response to the reception signal level or the reception error rate.

In a case where the reception signal rate is greater than or equal to the predetermined threshold, the control unit 14 performs a next control, at the time of transmitting a transmission signal at a next communication, regardless a status of the reception signal of the antenna in a non-selection status.

It is supposed that the antenna Ant1 is selected. The control unit 14 outputs the switching signal SW to the switch circuit 11 to make the switch circuit 11 switch the already selected antenna Ant1 to the non-selected antenna Ant2.

In this way, in the case where the reception status is not in the predetermined condition, the control unit 14 outputs the switching signal SW to the switch circuit 11 to make the switch circuit 11 switch the already selected antenna to the other antenna.

On the other hand, in a case where the reception signal level is less than or equal to the predetermined threshold, the control unit 14 dose not perform the switching of the antenna, and maintains the selected antenna.

The memory 15 includes a nonvolatile memory such as a flush ROM or the like, and is connected to the control unit 14. The memory 15 records, for example, a value of the threshold to be used for the judgment of a status of a reception signal or the like, or the status of the reception signal which was monitored by the control unit 14 or the like. The memory 15 records information of a phone number, and an electronic mail address or the like, a data of an incoming melody, and an audio message or the like.

The key operation unit 16 has, ten keys or the like, corresponding to a termination key (a call termination key), a power key, a start key (a call start key), and number keys or the like. The key operation unit 16 provides input information given from a user by operating these keys to the control unit 14.

The display unit 17 has a display devise such as a LCD (Liquid Crystal Display) or an Organic EL (Electro Luminescence) or the like. The display unit 17 displays a phone number, various messages or a text data or the like, inputted for performing phone call functions, on the display device.

The audio processor unit 18 has an audio processor circuit, and is connected to the speaker 18a performing an audio output for a phone call, the microphone 18b performing a voice input, and the control unit 14, respectively. The audio processor unit 18 performs the predetermined processing for a voice collected by the microphone 18b, and outputs a processed signal to the control unit 14. The audio processor unit 18 performs the predetermined processing for audio information including a sound indicating reception of a call or the like, supplied by the control unit 14.

The speaker 18a is connected to the audio processor unit 18. The speaker 18a outputs audio information including the sound indicating reception of a call or the like, supplied by the audio processor unit 18, as a sound wave.

The microphone 18b is connected to the audio processor unit 18. The microphone 18b inputs a voice or the like, by the user when the phone call, converts the input voice or the like into an electrical signal, and outputs the same to the audio processor unit 18.

Explanation will be made, on the switching operation of an antenna of which the wireless communication terminal apparatus 10 according to the present embodiment carries out the communication with the base station 20.

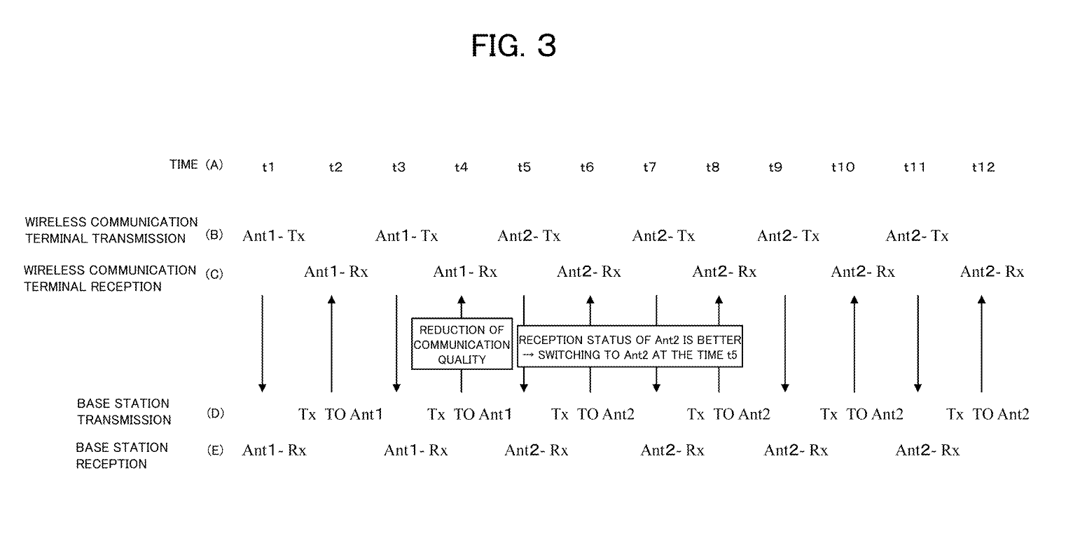

FIG. 3 is a view showing an example of the switching operation of an antenna, which is carried out at the time where the wireless communication terminal apparatus according to the present embodiment carries out the communication with the base station. Namely, in the explanation with reference to the FIG. 3, a signal transmitted by the wireless communication terminal apparatus or the base station is referred as Tx, a signal which is received by the apparatus or the station is referred as Rx. At the beginning (time t1), it is supposed that the antenna Ant1 is selected.

As shown in FIG. 3, at the time t1, the communication unit 12 of the wireless communication terminal apparatus 10 transmits the signal Tx to the base station 20 by the means of the antenna Ant1 on the basis of the control of the control unit 14. The base station 20 receives the signal Tx as the reception signal Rx from the antenna Ant1 provided on the wireless communication terminal apparatus 10.

After that, at the time t2, the base station 20 transmits the signal Tx to the antenna Ant1, which was selected by the wireless communication terminal apparatus 10 at the time t1. The communication unit 12 of the wireless communication terminal apparatus 10 receives the signal Tx as the reception signal Rx by the means of the antenna Ant1 from the base station 20 on the basis of the control of the control unit 14.

At this time, the control unit 14 monitors the reception error rate of the reception signal, since the control unit 14 judged that the reception error rate was less than or equal to the predetermined threshold, the control unit 14 maintains the selection status of the antenna Ant1.

At the time t3, also, the wireless communication terminal apparatus 10 carries out the communication with the base station 20 by performing the same operation at the time t1.

At the time t4, it is supposed that a radio wave condition is deteriorated. A communication quality detected by the control unit 14 would be lowered due to the deteriorated condition, and thus the value of the reception error rate will become higher than that before the time t3.

At this time, the base station 20 transmits the signal Tx to the antenna Ant1, which was used by the wireless communication terminal apparatus 10 at the time t3. The communication unit 12 of the wireless communication terminal apparatus 10 receives the signal Tx as the reception signal Rx by the means of the antenna Ant1 from the base station 20.

At the time t4, it is supposed that the control unit 14 detects that the monitoring reception error rate is higher than the predetermined threshold.

At the time t5 where the wireless communication terminal apparatus 10 transmits the signal Tx to the base station 20 at a next communication, the control unit 14 outputs the switching signal SW to the switch circuit 11 to make the switch circuit 11 switch from the antenna Ant1 to the antenna Ant2. The switch circuit 11 switches an antenna from the antenna Ant1 to the antenna Ant2.

The communication unit 12 of the wireless communication terminal apparatus 10 transmits the signal Tx to the base station 20 by the means of the antenna Ant2. The base station 20 receives the signal Tx as the reception signal Rx from the antenna Ant2 provided on the wireless communication terminal apparatus 10.

At the time t6, the base station 20 transmits the signal Tx as the transmission signal Tx to the antenna Ant2, which was selected by the wireless communication terminal apparatus 10 at the time t5. The communication unit 12 of the wireless communication terminal apparatus 10 receives the signal Tx as the reception signal Rx by the means of the antenna Ant2 from the base station 20.

After the time t7, also, the control unit 14 monitors the reception error rate at every time of receiving the signal Rx. As the example showing in FIG. 3, since there is no change in the reception error rate after the time t7, the antenna Ant2 is maintained. If the reception error rate changes, the control unit 14 controls the switch circuit 11 for making the switch circuit 11 select the other antenna.

As described above, the wireless communication terminal apparatus 10 switches, in the case where the reception status is not in the predetermined condition, the switching is carried out, from the selected antenna to the other antenna at the time of transmitting a signal at a next communication. Therefore, for example, at the time t6 shown in FIG. 3, the base station 20 can transmit the signal Tx to the antenna Ant2, which was used by the wireless communication terminal apparatus 10 at the time t1.

As a result, there is no inconsistent between a timing for the wireless communication terminal apparatus 10 switching the antenna and a directivity of the adaptive array antenna of the base station 20. Therefore, the wireless communication terminal apparatus 10 can measure accurately the reception signal level of the selected antenna when receiving the signal from the base station 20.

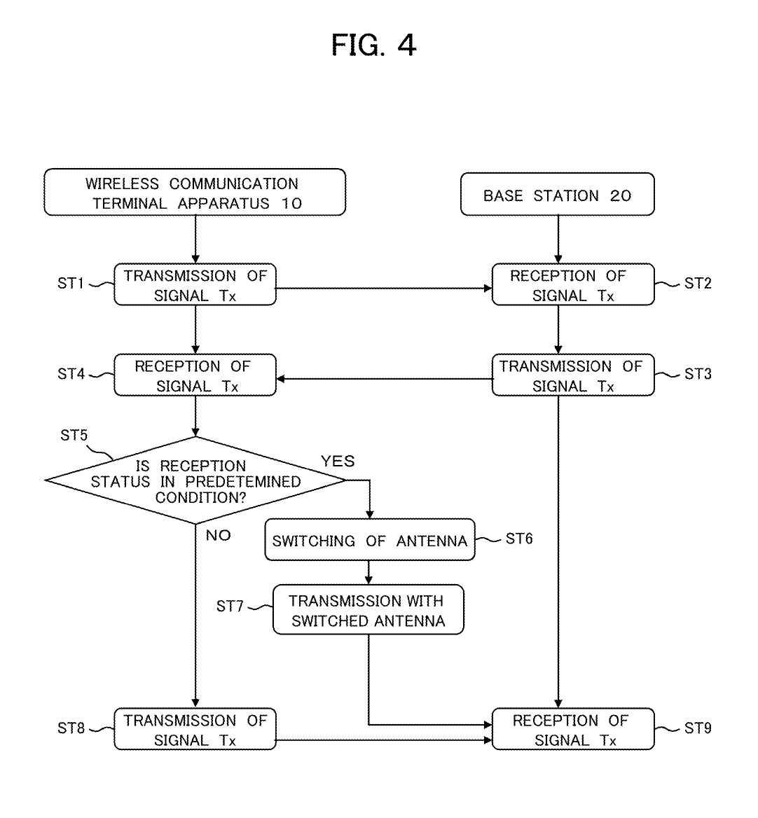

The operation of the communication wireless system according to the present embodiment will be explained with reference to FIG. 4.

FIG. 4 is a flowchart showing an example of the operation of the communication wireless system according to the present embodiment. As the explanation with reference to FIG. 4, it is supposed that the antenna Ant1 is selected at the beginning.

As shown in FIG. 4, the communication unit 12 of the wireless communication terminal apparatus 10 transmits the signal Tx to the base station 20 by means of the antenna Ant1 on the basis of the control of the control unit 14 (Step ST1). The base station 20 receives the signal Tx from the antenna Ant1 provided on the wireless communication terminal apparatus 10 (Step ST2). These sequences of the operations correspond to the operations at the time t1 or the time t3 shown in FIG. 3.

After that, the base station 20 transmits the signal Tx to the antenna Ant1, which was selected by the wireless communication terminal apparatus 10 at the step ST1 (Step ST3). The communication unit 12 of the wireless communication terminal apparatus 10 receives the signal Tx by means of the antenna Ant1 from the base station 20 on the basis of the control of the control unit 14 (Step ST4).

The control unit 14 monitors the reception status, and judges that the reception status is in the predetermined condition or not (Step ST5). The operations of the steps ST3-ST5 correspond to, for example, the operations at the time t2 or the time t4 shown in FIG. 3.

In the case where the judgment is carried out that the reception error rate is greater than or equal to the predetermined threshold (YES), the control unit 14 outputs the switching signal SW to the switch circuit 11 to make the switch circuit 11 select the antenna Ant2. The switch circuit 11 switches an antenna from the antenna Ant1 to the antenna Ant2 by the switching signal SW provided by the control unit (Step ST6).

The communication unit 12 of the wireless communication terminal apparatus 10 transmits the signal Tx to the base station 20 by means of the antenna Ant2 (Step ST7), and restarts the operation of the step ST4.

The base station 20 receives the signal Tx from the antenna Ant2 provided on the wireless communication terminal apparatus 10 (Step ST9), and restarts the operation of the step ST3.

The operations of the steps ST6-ST7, and the step ST9 correspond to, for example, the operation at the time t5 shown in FIG. 3.

On the other hand, in the case where the control unit 14 judges that the reception error rate is less than or equal to the predetermined threshold (NO), the antenna Ant1 is maintained as the selected antenna, the communication unit 12 of the wireless communication terminal apparatus 10 transmits the signal Tx to the base station 20 by means of the antenna Ant1 (Step ST8), and restarts the operation of the step ST4.

The base station 20 receives the signal Tx from the antenna Ant1 provided on the wireless communication terminal apparatus 10 (Step ST9), and restarts the operation of the step ST3. The operations of the step ST8 and the step ST9 correspond to, for example, the operations at the time t3 shown in FIG. 3.

As described above, the wireless communication terminal apparatus 10 according to the present embodiment switches the selected antenna to the other antenna at the time of transmitting a transmission signal at a next communication in the case where the reception status is not in the predetermined condition. The base station 20 transmits the signal to the antenna, which was selected by the wireless communication terminal apparatus 10.

Namely, the antenna of the object to which the base station 20 transmits the transmission signal, and the antenna by which the wireless communication terminal apparatus 10 receives a reception signal from the base station 20 meet. As a result, there is no inconsistent between a timing at which the wireless communication terminal apparatus 10 switches the antenna, and a directivity of the adaptive array antennas of the base station 20.

Therefore the wireless communication terminal apparatus 10 can measure accurately the reception level of the selected antenna when receiving the signal from the base station 20. The wireless communication terminal apparatus 10 can communicate smoothly with the base station 20 having the adaptive array antenna. Further, it is advantage to improve the quality of the communication.

An example will be shown on the improvement of the communication quality in a case when applying the present invention to a wireless communication terminal apparatus or the like.

For example, there is made the measurements of the reception error rates for the wireless communication terminal apparatus 10, and a general wireless communication terminal apparatus for diversity system having two systems of antennas (called as the wireless communication terminal apparatus A). The present wireless communication terminal apparatus 10 has two built-in antennas, and the general wireless communication terminal for diversity system apparatus has a built-in antenna and a rod antenna. The result of the measurements will be mentioned.

There is made the measurements of the reception error rates of the wireless communication terminal apparatus 10 and the wireless communication terminal apparatus A, respectively, by moving the wireless communication terminal apparatus 10 and the wireless communication terminal apparatus A from a position adjacent to one base station to a position where the both apparatuses can communicate with this base station, along a predetermined route.

As a result, it shows a tendency that the reception error rate in a case using the built-in antenna is higher than that in a case using the rod antenna, but, it was achieved to maintain the reception error rate of the wireless communication terminal apparatus 10 as to the same level of that of the wireless communication terminal apparatus A. According to the measurement results, it is deemed that an effect of the present invention is proved.

According to the present embodiment, there is an advantage to expand the reception area in which the apparatus can receive the signal from the base station.

Since it is possible to realize the sequences of the operations (for example, steps ST4-ST8 shown in FIG. 4) of switching the antenna by a software, the present invention can be applied easily to the wireless communication terminal apparatus or the like.

The description was given in the case where the judgment (for example, the step ST5 shown in FIG. 4) of the status of the reception signal was as the reception error rate, it is also possible to judge the status of the reception signal by the amplitude of the reception signal.

In this case, the control unit 14 monitors the reception level of the selected antenna, and judges that high or low of the reception level is in the predetermined condition or not. The reception level means, for example, a reception electric field strength. The lower the reception level may result in an introduction of a larger noise in/on an audio or a picture.

In a case where the reception level is less than or equal to the predetermined threshold, the control unit 14 outputs the switching signal SW to the switch circuit 11 to make the selected antenna be switched to the other antenna. The switch circuit 11 switches the selected antenna to the other antenna by the switching signal SW provided by the control unit 14. In a case where the reception level is greater than or equal to the predetermined threshold, the control unit 14 maintains the selected antenna as well.

In the present embodiment, the wireless communication terminal apparatus for diversity system comprising two antennas was described as an example, the number of antenna may be comprised of, for example, four antennas or the like, a plurality of antennas.

In this case, the control unit 14 selects the antenna of which the reception signal is in the best condition among the plurality of the antennas. The switch circuit 11 switches to the antenna of which the reception signal is in the best condition by the switching signal SW provided by the control unit 14.

In the present embodiment, a wireless communication terminal for diversity system was described as an example, the present invention is not limited to a wireless communication terminal apparatus for diversity system. The present invention can apply for overcoming the obstacles, for example, a multipath interference, a selectivity fading.

The present invention can be applied to various wireless communication terminal apparatuses which performs the above-mentioned switching operation of antennas.

1. A wireless communication terminal apparatus comprising:
a plurality of antennas;
a switch circuit for switching to one selected antenna among the plurality of antennas, for carrying out a communication;
a control unit for selecting another antenna among antennas in a non-selection status in response to the status of the reception signal, in a case where a status of a reception signal of an antenna in a selection status is not in the predetermined condition, and regardless a status of the reception signal of the antennas in a non-selection status, and controlling the switch circuit for making the switching of another antenna in a non-selection status at a transmission.

2. The wireless communication terminal apparatus according to claim 1, wherein
the plurality of antennas comprise a first antenna and a second antenna,
the reception status is large or small of the reception error rate, and
the control unit controls, in a case where the reception error rate is greater than or equal to the predetermined reception error rate, the switch circuit for making the switching from the selected first antenna to the second antenna in a non-selection status.

3. The wireless communication terminal apparatus according to claim 1, wherein
the plurality of antennas comprise the first antenna and the second antenna,
the reception status is high or low of the reception level, and
the control unit controls, in a case where the reception level is less than or equal to the predetermined reception level, the switch circuit for making the switching from the selected first antenna to the second antenna in a non-selection status.

4. The wireless communication terminal apparatus according to any of claims 1 to 3, wherein
a communication object is comprised of an adaptive array antenna.

5. A wireless communication system in which a wireless communication terminal apparatus and a base station for carrying out a communication with the wireless communication terminal apparatus are connected to a network:
the wireless communication terminal apparatus comprising:
a plurality of antennas;
a switch circuit for switching to one selected antenna among the plurality of antennas, for carrying out a communication;
a control unit for selecting another antenna among antennas in a non-selection status in response to the status of the reception signal, in a case where a status of a reception signal of an antenna in a selection status is not in the predetermined condition, and regardless a status of the reception signal of the antennas in a non-selection status, and controlling the switch circuit for making the switching of another antenna in a non-selection status at a transmission.

6. A wireless communication method comprising:
a step for switching to one selected antenna among a plurality of antennas, for carrying out a communication;
a step for selecting another antenna among antennas in a non-selection status in response to the status of the reception signal, in a case where a status of a reception signal of an antenna in a selection status is not in the predetermined condition, and regardless a status of the reception signal of the antennas in a non-selection status, and controlling the switch circuit for making the switching of another antenna in a non-selection status at a transmission.
